(19) United States
(12) Patent Application Publication
(10) Pub. No.: US 2008/0233485 A1
(43) Pub. Date: Sep. 25, 2008

(54) NON-AQUEOUS ELECTROLYTE SECONDARY BATTERY

(75) Inventors: Daizo JITO, Moriguchi City (JP); Katsuaki TAKAHASHI, Moriguchi City (JP); Kazuhiro HASEGAWA, Moriguchi City (JP); Hiroyuki FUJIMOTO, Moriguchi City (JP); Ikuro NAKANE, Moriguchi City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 12/053,940

(22) Filed: Mar. 24, 2008

(30) Foreign Application Priority Data
Mar. 23, 2007 (JP) 2007-76208

(51) Int. Cl. H01M 10/40

(52) U.S. Cl. 429/332; 429/188; 429/206

(57) ABSTRACT

A non-aqueous electrolyte secondary battery comprises: a positive electrode using a positive electrode active material consisting of metal composite oxide containing lithium having a laminated structure; a negative electrode; and a non-aqueous electrolyte dissolving an electrolyte in a non-aqueous solvent; wherein the positive electrode active material contains 50 mol % or more of nickel in metal excluding lithium, and cyclic ether is added in the range of 0.1 volume % to 2.0 volume % to the non-aqueous electrolyte.

### RELATED APPLICATION

This application is based on application No. 2007-76208 filed in Japan, the contents of which are hereby incorporated by reference.

### BACKGROUND OF THE INVENTION

1. Field of the Invention

The present invention relates to a non-aqueous electrolyte secondary battery employing a positive electrode using a positive electrode active material consisting of metal composite oxide containing lithium having a laminated structure, a negative electrode, and a non-aqueous electrolyte dissolving an electrolyte in a non-aqueous solvent. More particularly, the invention relates to a non-aqueous electrolyte secondary battery using a positive electrode active material consisting of metal composite oxide containing lithium wherein a large amount of nickel is contained for the purpose of enhancing battery capacity, which is characterized in that swelling of the battery in the case of preservation in charging condition is prevented and degradation of capacity thereof is suppressed.

2. Description of the Related Art

In recent years, a non-aqueous electrolyte secondary battery, which employs a non-aqueous electrolyte wherein lithium ion is moved between a positive electrode and a negative electrode to perform charging and discharging, has been widely used as a new type of secondary battery that achieves high power and high energy density.

In such a non-aqueous electrolyte secondary battery, as a positive electrode active material of the positive electrode, lithium cobaltate, LiCoO₂ having a laminated structure generally featuring excellent stability and excellent charge/discharge characteristics, has been widely used.

However, Co, which is used for lithium cobaltate, is rare resource, so that the use of Co has problems of great production cost and unstable supply. Further, because the non-aqueous electrolyte secondary battery as described above has been utilized for various fields, such as, power source of hybrid automobiles, demands for higher capacity have been increasing.

Therefore, as the positive electrode active material, the use of metal composite oxide containing lithium wherein a large amount of nickel which has a larger charge/discharge capacity than lithium cobaltate per unit mass is contained, has been considered.

However, the non-aqueous electrolyte secondary battery using metal composite oxide containing lithium wherein a large amount of nickel is contained as the positive electrode active material has problems as follows. In the case that the battery is preserved in charging condition under high temperature environment, the positive electrode active material reacts with the non-aqueous electrolyte and generation of gas is caused resulting in the swelling of the battery, and a battery resistance is risen because of materials formed by such a reaction and charge/discharge characteristics are degraded.

Therefore, in recent years, in order to prevent a battery from swelling caused by the gas generated from the reaction between the positive electrode active material and the non-aqueous electrolyte, it has been disclosed to decrease the amount of lithium carbonate in metal composite oxide containing lithium wherein a large amount of nickel is contained as a positive electrode active material of which PH is set to be in the range of 10 to 11.5 (see document 1, Japanese Patent No. 3567131).

A problem with such a non-aqueous electrolyte secondary battery as disclosed in the document 1 which uses the positive electrode active material wherein the amount of lithium carbonate is decreased and PH is set to be in the range of 10 to 11.5, has been that it is difficult to sufficiently restrict the reaction between the positive electrode active material and the non-aqueous electrolyte and that the swelling of the battery is still caused in the case of preservation in charging condition under high temperature environment.

It has also been disclosed that metal composite oxide containing lithium wherein a large amount of nickel is contained as a positive electrode active material is washed with water to remove lithium carbonate (see document 2, Japanese Publication No. 2003-17054).

As disclosed in the document 2, if the positive electrode active material of metal composite oxide containing lithium wherein a large amount of nickel is contained is washed with water, the reaction between the positive electrode active material and the non-aqueous electrolyte in the case of preservation in charging condition under high temperature environment is restricted. However, a problem with such a non-aqueous electrolyte secondary battery has been that, in metal composite oxide containing lithium, the amount of nickel getting into a site for lithium is increased by the washing, and a resistance in the surface of the positive electrode active material is risen, and as a result, a non-aqueous electrolyte secondary battery having a high capacity cannot be attained.

### SUMMARY OF THE INVENTION

The present invention is made to solve the above described problems, in a non-aqueous electrolyte secondary battery employing a positive electrode, a negative electrode, and a non-aqueous electrolyte dissolving an electrolyte in a non-aqueous solvent, in the case that metal composite oxide containing lithium wherein a large amount of nickel is contained is used as a positive electrode active material for the purpose of enhancing the battery capacity.

An object of the present invention is, namely, in the non-aqueous electrolyte secondary battery using metal composite oxide containing lithium wherein a large amount of nickel is contained as the positive electrode active material, to prevent the battery from swelling caused by gas generated from a reaction between the positive electrode active material and the non-aqueous electrolyte in the case of preservation in charging condition under high temperature environment and to suppress degradation of battery capacity.

A non-aqueous electrolyte secondary battery of the present invention comprises: a positive electrode using a positive electrode active material consisting of metal composite oxide containing lithium having a laminated structure; a negative electrode; and a non-aqueous electrolyte dissolving an electrolyte in a non-aqueous solvent; and the positive electrode active material contains 50 mol % or more of nickel of metal excluding lithium, and cyclic ether is added in a range of 0.1 to 2 volume % to said non-aqueous electrolyte.

In this invention, the non-aqueous electrolyte secondary battery uses the positive electrode active material consisting of metal composite oxide containing lithium wherein 50 mol % or more of nickel is contained in metal excluding lithium, therefore, charge/discharge capacity per weight is enhanced, making it possible to attain a high-capacity non-aqueous electrolyte secondary battery.

Moreover, in this invention, cyclic ether is added in the range of 0.1 to 2.0 volume % to the non-aqueous electrolyte, therefore, cyclic ether is decomposed and a film is formed on the surface of the positive electrode active material in initial charging condition. Due to the film formed, the reaction between the positive electrode active material and the non-aqueous electrolyte is restricted. The reason why the range of cyclic ether to be added to the non-aqueous electrolyte needs to be 0.1 to 2.0 volume % is as follows. If the amount of cyclic ether is 0.1 volume % or less, the formation of the sufficient film on the surface of the positive electrode active material is hard to be attained. On the other hand, if the amount of cyclic ether is more than 2.0 volume %, cyclic ether is left without being decomposed in initial charging condition, which gives a bad effect on the battery capacity and discharge characteristics. Further, cyclic ether is decomposed by the reaction between the positive electrode active material and itself, which causes the swelling of the battery.

As a consequence, with the non-aqueous electrolyte secondary battery of the present invention, without causing the capacity degradation as in the case of the washing of the positive electrode active material with water, the swelling of the battery caused by gas generated from the reaction between the positive electrode active material and the non-aqueous electrolyte is prevented even in the case of preservation in charging condition under high temperature environment.

These and other objects, advantages and features of the invention will become apparent from the following description thereof taken in conjunction with the accompanying drawings which illustrate specific embodiment of the invention.

### BRIEF DESCRIPTION OF THE DRAWINGS

FIG. 1 is a schematic partial cross-sectional view and a schematic perspective view illustrating a flat shaped electrode fabricated in Examples 1 to 7 and Comparative Examples 1 to 8 of the present invention;

FIG. 2 is a schematic plain view of a non-aqueous electrolyte secondary battery fabricated in Examples 1 to 7 and Comparative Examples 1 to 8.

### DESCRIPTION OF THE PREFERRED EMBODIMENTS

Hereinafter, preferred embodiments of non-aqueous electrolyte secondary batteries according to the present invention will specifically be described.

A non-aqueous electrolyte secondary battery of the present invention comprises: a positive electrode using a positive electrode active material consisting of metal composite oxide containing lithium wherein 50 mol % or more of nickel is contained in metal excluding lithium; and a non-aqueous electrolyte wherein cyclic ether is added in the range of 0.1 to 2.0 volume %.

Herein, to enhance charge/discharge capacity per unit weight of the positive electrode active material and attain a high-capacity non-aqueous electrolyte secondary battery, it is preferable to use as the positive electrode active material metal composite oxide containing lithium presented by the general formula LiₐNi_{b}Co_{c}M_{d}O₂₊ₑ, where M is at least one element selected from Al, Mn, Mg and Ca, 0.2≦a≦1.2, 0.6≦b≦0.9, 0.1≦c≦0.4, 0≦d≦0.2, −0.2≦e≦0.2, and b+c+d=1.

The reason why the mol ratio b of Ni needs to be not less than 0.6 in metal composite oxide containing lithium is to enhance charge/discharge capacity per unit weight.

The reason why Co needs to be contained in metal composite oxide containing lithium is to enhance discharge characteristics of the positive electrode active material. Further, the reason why the mol ratio c of Co needs to be in the range of 0.1≦c≦0.4 is as follows. If the mol ratio c is less than 0.1, it is difficult to enhance discharge characteristics sufficiently. On the other hand, if the mol ratio c is over 0.4, the charge/discharge capacity per unit weight of the positive electrode active material is decreased.

Further, at least one element selected from Al, Mn, Mg and Ca may be contained as M in metal composite oxide containing lithium presented by the above general formula, which makes it possible to enhance stability to heat and to suppress rise of resistance with preventing nickel from getting into a site for lithium. However, if the mol ratio d of M is large, the charge/discharge capacity per unit weight of the positive electrode active material is decreased. Therefore, it is preferable that mol ratio d of M is 0.2 or less.

Examples of usable cyclic ether added to the non-aqueous electrolyte include furan, 2-methyl furan, tetrahydrofuran, 2-methyl tetrahydrofuran, 1,4-dioxane, 1,3-dioxane, and crown ether (12-crown-4 ether, 15-crown-5 ether). Particularly, the use of cyclic ether, such as furan or 2-methyl furan, having unsaturation bond makes it possible to form a suitable film on the surface of the positive electrode active material by the decomposition of the cyclic ether when the non-aqueous electrolyte secondary battery is in initial charging condition, and is therefore preferable.

As the non-aqueous electrolyte wherein cyclic ether is added, any known non-aqueous electrolyte dissolving an electrolyte in a non-aqueous solvent that has been conventionally used may be employed.

As the non-aqueous solvent, any known non-aqueous solvent that has been conventionally used may be employed. Examples of the non-aqueous solvent include a mixed solvent wherein cyclic carbonate, such as ethylene carbonate and propylene carbonate, and chain carbonate, such as dimethyl carbonate, ethyl methyl carbonate and diethyl carbonate, are mixed.

Here, if the amount of cyclic carbonate in the mixed solvent is too large, the reaction with the positive electrode active material in charging condition tends to occur easily under high temperature environment. On the other hand, if the amount of cyclic carbonate is too small, lithium ion conductivity in the non-aqueous electrolyte is degraded because of insufficient ion dissociation of the non-aqueous electrolyte, so that a sufficient battery capacity cannot be attained. Therefore, it is preferable that the amount of cyclic carbonate in the mixed solvent be within the range of 10 volume % to 30 volume %.

Moreover, as the chain carbonate, diethyl carbonate is preferably used because an oxidative decomposition reaction between the positive electrode active material and itself in charging condition is hardly progressed under high temperature environment.

In the non-aqueous electrolyte, any known electrolyte that has conventionally been used may be employed as an electrolyte to be dissolved in the non-aqueous solvent. Examples include LiPF₆, LiBF₄, LiCF₃SO₃, LiC₄F₉SO₃, LiN(CF₃SO₂)₂, LiN(C₂F₅SO₂)₂, LiAsF₆, LiN(CF₃SO₂) (C₄F₉SO₂), LiC(CF₃SO₂)₃, LiC(C₂F₅SO₂)₃, LiClO₄, Li₂B₁₀Cl₁₀, LiB(C₂O₄)₂, LiB(C₂O₄)F₂, LiP(C₂O₄)₃, LiP(C₂O₄)₂F₂, Li₂B₁₂Cl₁₂, which may be used either alone or in combination.

Further, it is preferable that vinylene carbonate is added to the non-aqueous electrolyte in the range of 0.5 to 4.0 weight % in order to suppress the rise of the battery resistance in the case that the non-aqueous electrolyte secondary battery is preserved in charging condition under high temperature environment. The reason is thought to be that a more suitable film is formed on the positive electrode active material by addition of vinylene carbonate.

In the non-aqueous electrolyte secondary battery, any known negative electrode active material that has conventionally been used may be employed as a negative electrode active material of the negative electrode. In order to increase energy density of the battery, it is preferable that a material, for example, a carbon material such as graphite, lithium metal and lithium alloy that has a relatively low electric potential in charge/discharge reactivity is used as the negative electrode active material. Particularly, graphite material is more preferably used. The use of graphite material makes it possible to attain a high-capacity battery because graphite material is excellent in reversibility in insertion/de-insertion reaction of lithium and has a large charge/discharge capacity per weight.

In order to enhance the capacity of the non-aqueous electrolyte secondary battery, it is preferable that the density of the negative electrode mixture is high. However, if the density of the negative electrode mixture is too high, the permeation of the non-aqueous electrolyte into the negative electrode reduces, which causes a deterioration of the discharging characteristics of the battery and results in a degradation of the battery capacity. Therefore, it is preferable that the density of the negative electrode mixture be within the range of 1.5 g/cm³ to 1.9 g/cm³.

Hereinbelow, examples will be specifically described of the non-aqueous electrolyte secondary battery according to the present invention, it will be demonstrated by the comparison with comparative examples that the non-aqueous electrolyte secondary batteries in the examples are capable of preventing swelling of the battery even in the case of preservation in charging condition under high temperature environment. It is to be noted that the non-aqueous electrolyte secondary batteries according to the present invention should not be limited to the following examples thereof and suitable changes and modifications may be made thereto within the scope of the invention.

### Example 1

In Example 1, a positive electrode, a negative electrode and a non-aqueous electrolyte fabricated in the following manner were used.

Preparation of Positive Electrode

A positive electrode was prepared as follows. LiOH and Ni_{0.80}Co_{0.17}Al_{0.03}(OH)₂ which is metal composite hydroxide containing nickel as a main component were kneaded using Ishikawa-style mortar for kneading so that the mol ratio is to be 1.05:1, and the resultant was heat-treated at 720° C. for 20 hours in an oxygen atmosphere; thereafter, this was crushed, whereby a positive electrode active material of transition metal composite oxide containing lithium of which average particle diameter is about 10 μm and of which composition was Li_{1.05}Ni_{0.80}Co_{0.17}Al_{0.03}O₂ was obtained. Then, 2.0 g of the positive electrode active material thus prepared was stirred in 100 g of water for 10 minutes, and the supernatant liquor thereof was measured for determining PH. The PH of the supernatant liquor was 10.8.

Then, the positive electrode active material of Li_{1.05}Ni_{0.80}Co_{0.17}Al_{0.03}O₂, a carbon material as a conductive agent, and polyvinylidene fluoride as a binding agent were mixed at the weight ratio of 95:2.5:2.5, and the resultant mixture was added to N-methyl-2-pyrolidone which is a solvent for dispersion and kneaded. Thus was obtained positive electrode mixture slurry. Next, the positive electrode mixture slurry was applied on both sides of a positive electrode collector formed of aluminum foil, and then was dried, and rolled by a rolling roller. Thus was obtained a positive electrode of which mixture density was 3.50 g/cm³. Further, a positive electrode collector tab was installed thereto.

Preparation of Negative Electrode

A negative electrode was prepared as follows. A negative electrode active material of artificial graphite and styrene-butadiene rubber as a binding agent were added to an aqueous solution dissolving carboxymethyl cellulose as a viscosity improver and were kneaded to prepare negative electrode mixture slurry. The weight ratio of artificial graphite, styrene-butadiene rubber and carboxymethyl cellulose in the negative electrode mixture slurry was 97.5:1.5:1.0. Next, the negative electrode mixture slurry was applied on both sides of a negative electrode collector formed of aluminum foil, and then was dried, and rolled by a rolling roller. Thus was obtained a negative electrode of which mixture density was 1.60 g/cm³. Further, a negative electrode collector tab was installed thereto.

Preparation of Non-Aqueous Electrolyte

A non-aqueous electrolyte was prepared as follows. A mixed solvent wherein ethylene carbonate which is cyclic carbonate and ethyl methyl carbonate which is chain carbonate were mixed in the volume ratio of 3:7 was prepared. Lithium hexafluorophosphate, LiPF₆, was dissolved as an electrolyte in the mixed solvent so that the concentration of the electrolyte was 1 mol/l. Further, 2.0 weight % of vinylene carbonate (VC) and 1.0 volume % of 2-methylfuran which is cyclic ether having unsaturation bond were added to the above-described mixture. Thus was obtained a non-aqueous electrolyte.

Fabrication of Battery

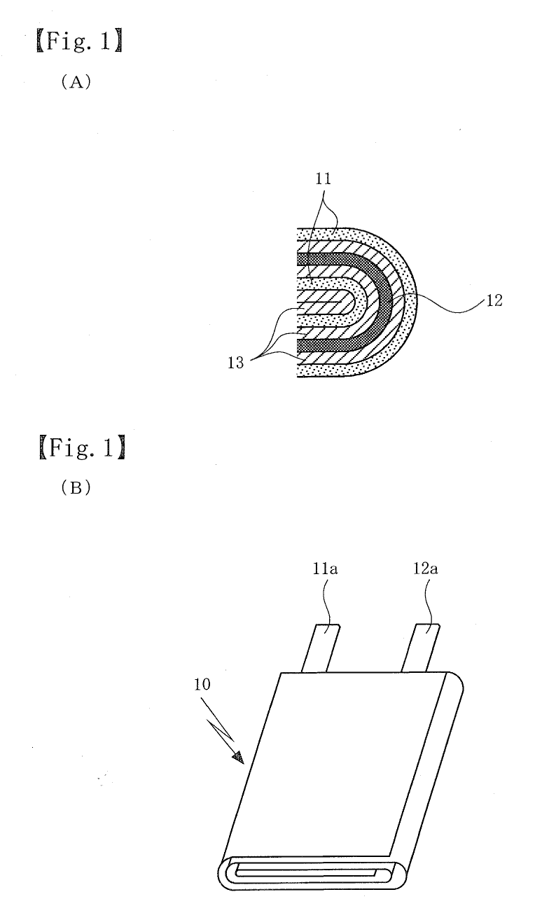

A battery was fabricated in the following manner. As shown in FIGS. 1(A) and 1(B), a separator 13 formed of a fine porous polypropylene film was interposed between a positive electrode 11 and a negative electrode 12, and these components were spirally wound, and then was pressed. Thus was obtained a flat electrode 10.

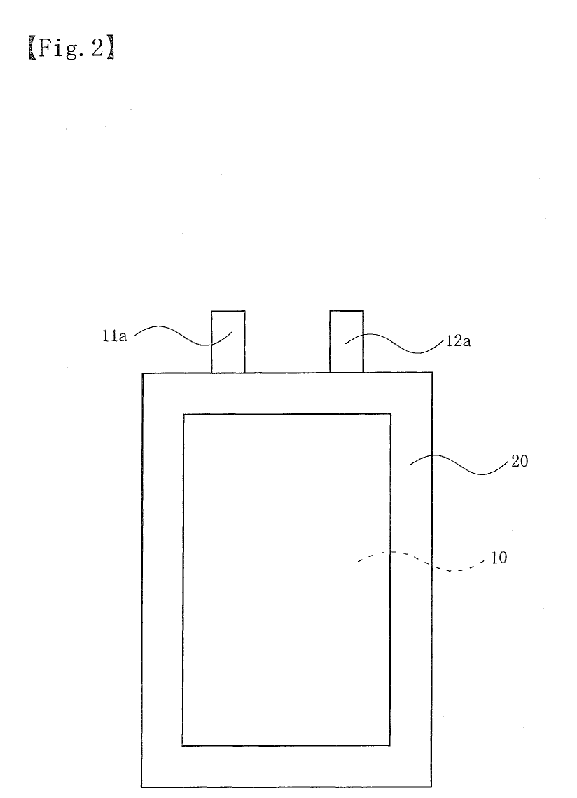

Next, as shown in FIG. 2, the flat electrode 10 was accommodated in a battery case 20 comprised of aluminum lamination film, and the non-aqueous electrolyte prepared in the above-mentioned manner was poured in the battery case 20. The open area of the battery case 20 was sealed to thrust out a positive electrode collector tab 11a installed to the positive electrode 11 and a negative electrode collector tab 12a installed to the negative electrode 12. Thus a non-aqueous electrolyte secondary battery having a battery standard size of 6.2 cm long, 3.5 cm wide, and 3.6 mm thickness was obtained.

### Example 2

In Example 2, the non-aqueous electrolyte was prepared by adding 2.0 weight % of vinylene carbonate (VC) and 0.5 volume % of furan which is cyclic ether having unsaturation bond. A non-aqueous electrolyte secondary battery of Example 2 was fabricated in the same manner as in the foregoing Example 1 except for the non-aqueous electrolyte.

### Example 3

In Example 3, the non-aqueous electrolyte was prepared by adding 2.0 weight % of vinylene carbonate (VC) and 1.0 volume % of tetrahydrofuran (THF) which is cyclic ether not having unsaturation bond. A non-aqueous electrolyte secondary battery of Example 3 was fabricated in the same manner as in the foregoing Example 1 except for the non-aqueous electrolyte.

### Example 4

In Example 4, the non-aqueous electrolyte was prepared by adding 1.0 volume % of tetrahydrofuran (THF) which is cyclic ether not having unsaturation bond without vinylene carbonate. A non-aqueous electrolyte secondary battery of Example 4 was fabricated in the same manner as in the foregoing Example 1 except for the non-aqueous electrolyte.

### Example 5

In Example 5, the non-aqueous electrolyte was prepared by adding 2.0 weight % of vinylene carbonate (VC) and 1.0 volume % of 2-methyl-tetrahydrofuran (2Me-THF) which is cyclic ether not having unsaturation bond. A non-aqueous electrolyte secondary battery of Example 5 was fabricated in the same manner as in the foregoing Example 1 except for the non-aqueous electrolyte.

### Example 6

In Example 6, the non-aqueous electrolyte was prepared by adding 2.0 weight % of vinylene carbonate (VC) and 1.0 volume % of 1,4-dioxane which is cyclic ether not having unsaturation bond. A non-aqueous electrolyte secondary battery of Example 6 was fabricated in the same manner as in the foregoing Example 1 except for the non-aqueous electrolyte.

### Example 7

In Example 7, the non-aqueous electrolyte was prepared by adding 2.0 weight % of vinylene carbonate (VC) and 1.0 volume % of 1,3-dioxane which is cyclic ether not having unsaturation bond. A non-aqueous electrolyte secondary battery of Example 7 was fabricated in the same manner as in the foregoing Example 1 except for the non-aqueous electrolyte.

### Comparative Example 1

In Comparative Example 1, the non-aqueous electrolyte was prepared by only adding 2.0 weight % of vinylene carbonate (VC). A non-aqueous electrolyte secondary battery of Comparative Example 1 was fabricated in the same manner as in the foregoing Example 1 except for the non-aqueous electrolyte.

### Comparative Example 2

In Comparative Example 2, the non-aqueous electrolyte was prepared by adding 2.0 weight % of vinylene carbonate (VC) and 2.0 volume % of diethyl ether (DEE) which is chain ether. A non-aqueous electrolyte secondary battery of Comparative Example 2 was fabricated in the same manner as in the foregoing Example 1 except for the non-aqueous electrolyte.

### Comparative Example 3

In Comparative Example 3, the non-aqueous electrolyte was prepared by adding 2.0 weight % of vinylene carbonate (VC) and 1.0 volume % of diethylene glycol dimethyl ether (DDE) which is chain ether. A non-aqueous electrolyte secondary battery of Comparative Example 3 was fabricated in the same manner as in the foregoing Example 1 except for the non-aqueous electrolyte.

### Comparative Example 4

In Comparative Example 4, the non-aqueous electrolyte was prepared by adding 2.0 weight % of vinylene carbonate (VC) and 1.0 volume % of butyl methyl ether which is chain ether. A non-aqueous electrolyte secondary battery of Comparative Example 4 was fabricated in the same manner as in the foregoing Example 1 except for the non-aqueous electrolyte.

Next, each of the non-aqueous electrolyte secondary batteries of Examples 1 to 7 and Comparative Examples 1 to 4 that were fabricated in the above-described manner was charged at the constant current of 800 mA until the voltage reached 4.2 V under room temperature environment. Then, each battery was further charged at the constant voltage of 4.2 V until the value of current reached 40 mA and thereafter discharged at the constant current of 800 mA until the battery voltage reached 2.5 V. Thus, a first charge/discharge performance was conducted.

Then, each of the non-aqueous electrolyte secondary batteries of Examples 1 to 7 and Comparative Examples 1 to 4 was charged at the constant current of 800 mA until the voltage reached 4.2 V under room temperature environment, and was further charged at the constant voltage of 4.2 V until the value of current reached 40 mA, in order to measure the thickness of each of non-aqueous electrolyte secondary batteries in charging condition before preservation.

Also, each of the non-aqueous electrolyte secondary batteries in charging condition was preserved in a homeothermal container of 85° C. for 3 hours. After that, each non-aqueous electrolyte secondary battery was taken out and left under room temperature environment for 1 hour. Then, the thickness of each non-aqueous electrolyte secondary battery after preservation was measured.

Then, the increment of the thickness of each non-aqueous electrolyte secondary battery after preservation against before preservation was measured. Then, the increment of the thickness in each of non-aqueous electrolyte secondary batteries was determined using relative indices wherein the increment of the thickness in Comparative Example 1 was taken as 100. The results are shown in Table 1 below.

TABLE 1

| | | Additives to | Increment |
|---|---|---|---|
| | | Non-aqueous | of |
| | Positive electrode | electrolyte | Battery |
| | active material | (Concentration) | thickness |
| Ex. 1 | Li_{1.05}Ni_{0.80}Co_{0.17}Al_{0.03}O₂ | VC (2.0 weight %) + | 47.4 |
| | | 2-methylfuran | |
| | | (1.0 volume %) | |
| Ex. 2 | Li_{1.05}Ni_{0.80}Co_{0.17}Al_{0.03}O₂ | VC (2.0 weight %) + | 57.5 |
| | | furan (0.5 volume %) | |
| Ex. 3 | Li_{1.05}Ni_{0.80}Co_{0.17}Al_{0.03}O₂ | VC (2.0 weight %) + | 65.3 |
| | | THF (1.0 volume %) | |
| Ex. 4 | Li_{1.05}Ni_{0.80}Co_{0.17}Al_{0.03}O₂ | THF (1.0 volume %) | 69.1 |
| Ex. 5 | Li_{1.05}Ni_{0.80}Co_{0.17}Al_{0.03}O₂ | VC (2.0 weight %) + | 72.3 |
| | | 2Me-THF | |
| | | (1.0 volume %) | |
| Ex. 6 | Li_{1.05}Ni_{0.80}Co_{0.17}Al_{0.03}O₂ | VC (2.0 weight %) + | 74.0 |
| | | 1,4-dioxane | |
| | | (1.0 volume %) | |
| Ex. 7 | Li_{1.05}Ni_{0.80}Co_{0.17}Al_{0.03}O₂ | VC (2.0 weight %) + | 79.6 |
| | | 1,3-dioxane | |
| | | (1.0 volume %) | |
| Comp. | Li_{1.05}Ni_{0.80}Co_{0.17}Al_{0.03}O₂ | VC (2.0 weight %) | 100 |
| Ex. 1 | | | |
| Comp. | Li_{1.05}Ni_{0.80}Co_{0.17}Al_{0.03}O₂ | VC (2.0 weight %) + | 111.6 |
| Ex. 2 | | DEE (2.0 volume %) | |
| Comp. | Li_{1.05}Ni_{0.80}Co_{0.17}Al_{0.03}O₂ | VC (2.0 weight %) + | 96.5 |
| Ex. 3 | | DDE (1.0 volume %) | |
| Comp. | Li_{1.05}Ni_{0.80}Co_{0.17}Al_{0.03}O₂ | VC (2.0 weight %) + | 94.4 |
| Ex. 4 | | butyl methyl ether | |
| | | (1.0 volume %) | |

As apparent from the results, among the non-aqueous electrolyte secondary batteries using the positive electrode active material of Li_{1.05}Ni_{0.80}Co_{0.17}Al_{0.03}O₂ wherein a large amount of nickel was contained, the non-aqueous electrolyte secondary batteries of Examples 1 to 7 employing the non-aqueous electrolyte containing cyclic ether exhibited a greater reduction in the increment of the thickness in the case of preservation in charging condition under high temperature environment compared with the non-aqueous electrolyte secondary battery of Comparative Example 1 employing the non-aqueous electrolyte not containing cyclic ether and the non-aqueous electrolyte secondary batteries of Comparative Examples 2 to 4 employing the non-aqueous electrolyte containing chain ether instead of cyclic ether. Particularly, the non-aqueous electrolyte secondary batteries of Examples 1 and 2 employing the non-aqueous electrolyte containing cyclic ether having unsaturation bond exhibited a further greater reduction in the increment of the thickness.

In addition, each of the non-aqueous electrolyte secondary batteries of Examples 3 and 4 was measured for the internal resistance before and after preservation in the case of charging condition under high temperature condition. Then, the rise of the internal resistance (mΩ) of each non-aqueous electrolyte secondary battery after preservation against before preservation was measured. The results are shown in Table 2 below.

TABLE 2

| | | Additives to | Rise of |
|---|---|---|---|
| | | Non-aqueous | Internal |
| | Positive electrode | electrolyte | resistance |
| | active material | (Concentration) | (mΩ) |
| Ex. 3 | Li_{1.05}Ni_{0.80}Co_{0.17}Al_{0.03}O₂ | VC (2.0 weight %) + | 13.6 |
| | | THF (1.0 volume %) | |
| Ex. 4 | Li_{1.05}Ni_{0.80}Co_{0.17}Al_{0.03}O₂ | THF (1.0 volume %) | 19.3 |

The results demonstrate that the non-aqueous electrolyte secondary battery of Example 3 employing the non-aqueous electrolyte containing cyclic ether and vinylene carbonate more suppressed the increment of the thickness of the battery as well as the rise of the internal resistance in the case of preservation in charging condition under high temperature environment compared with the non-aqueous electrolyte secondary battery of Comparative Example 4 employing the non-aqueous electrolyte not containing vinylene carbonate.

### Comparative Example 5

In Comparative Example 5, the positive electrode was prepared by using LiCoO₂ as the positive electrode active material. Also, the non-aqueous electrolyte was prepared by adding 2.0 weight % of vinylene carbonate (VC) and 1.0 volume % of tetrahydrofuran (THF). A non-aqueous electrolyte secondary battery of Comparative Example 5 was fabricated in the same manner as in the foregoing Example 1 except for the positive electrode and the non-aqueous electrolyte.

### Comparative Example 6

In Comparative Example 6, the positive electrode was prepared by using LiCoO₂ as the positive electrode active material. Also, as the same as Comparative Example 1, the non-aqueous electrolyte was prepared by adding only 2.0 weight % of vinylene carbonate (VC). A non-aqueous electrolyte secondary battery of Comparative Example 6 was fabricated in the same manner as in the foregoing Example 1 except for the positive electrode and the non-aqueous electrolyte.

Then, the increment of the thickness of each non-aqueous electrolyte secondary battery of Comparative Examples 5 and 6 after preservation in charging condition in the homeothermal container of 85° C. for 3 hours against before preservation, was measured. Next, the increment of the thickness in the non-aqueous electrolyte secondary battery of Comparative Example 5 was determined using relative indices wherein the increment of the thickness in Comparative Example 6 was taken as 100. The results are shown in Table 3 below.

TABLE 3

| | | Additives to | Increment of |
|---|---|---|---|
| | Positive electrode | Non-aqueous electrolyte | Battery |
| | active material | (Concentration) | thickness |
| Comp. | LiCoO₂ | VC (2.0 weight %) + THF | 90 |
| Ex. 5 | | (1.0 volume %) | |
| Comp. | LiCoO₂ | VC (2.0 weight %) | 100 |
| Ex. 6 | | | |

As apparent from the results, between the non-aqueous electrolyte secondary batteries of Comparative Examples 5 and 6 using the positive electrode active material of LiCoO₂, the non-aqueous electrolyte secondary battery of Comparative Example 5 employing the non-aqueous electrolyte containing cyclic ether exhibited a slightly greater reduction in the increment of the thickness in the case of preservation in charging condition under high temperature environment compared with the non-aqueous electrolyte secondary battery of Comparative Example 6 employing the non-aqueous electrolyte not containing cyclic ether. However, in the non-aqueous electrolyte secondary battery of Comparative Example 5, compared with the non-aqueous electrolyte secondary batteries using the positive electrode active material of Li_{1.05}Ni_{0.80}Co_{0.17}Al_{0.03}O₂ wherein a large amount of nickel was contained, the reduction in the increment of the thickness was smaller and the effects obtained by adding cyclic ether was decreased.

### Comparative Example 7

In Comparative Example 7, the positive electrode was prepared by using LiNi_{1/3}Co_{1/3}Mn_{1/3}O₂ as the positive electrode active material. Also, the non-aqueous electrolyte was prepared by adding 2.0 weight % of vinylene carbonate (VC) and 1.0 volume % of tetrahydrofuran (THF). A non-aqueous electrolyte secondary battery of Comparative Example 7 was fabricated in the same manner as in the foregoing Example 1 except for the positive electrode and the non-aqueous electrolyte.

### Comparative Example 8

In Comparative Example 8, the positive electrode was prepared by using LiNi_{1/3}Co_{1/3}Mn_{1/3}O₂ as the positive electrode active material. Also, as the same as Comparative Example 1, the non-aqueous electrolyte was prepared by only adding 2.0 weight % of vinylene carbonate (VC). A non-aqueous electrolyte secondary battery of Comparative Example 8 was fabricated in the same manner as in the foregoing Example 1 except for the positive electrode and the non-aqueous electrolyte.

Then, the increment of the thickness of each non-aqueous electrolyte secondary battery of Comparative Examples 7 and 8 after preservation in charging condition in the homeothermal container of 85° C. for 3 hours against before preservation, was measured. Next, the increment of the thickness in the non-aqueous electrolyte secondary battery of Comparative Example 7 was determined using relative indices wherein the increment of the thickness in Comparative Example 8 was taken as 100. The results are shown in Table 4 below.

TABLE 4

| | | Additives to | Increment of |
|---|---|---|---|
| | Positive electrode | Non-aqueous electrolyte | Battery |
| | active material | (Concentration) | thickness |
| Comp. | LiNi_{1/3}Co_{1/3}Mn_{1/3}O₂ | VC (2.0 weight %) + THF | 136 |
| Ex. 7 | | (1.0 volume %) | |
| Comp. | LiNi_{1/3}Co_{1/3}Mn_{1/3}O₂ | VC (2.0 weight %) | 100 |
| Ex. 8 | | | |

As a result, between the non-aqueous electrolyte secondary batteries Comparative Examples 7 and 8 using the positive electrode active material of LiNi_{1/3}Co_{1/3}Mn_{1/3}O₂, contrary to the case of the non-aqueous electrolyte secondary batteries using the positive electrode active material of Li_{1.05}Ni_{0.80}Co_{0.17}Al_{0.03}O₂ wherein a large amount of nickel was contained, the non-aqueous electrolyte secondary battery of Comparative Example 7 employing the non-aqueous electrolyte containing cyclic ether exhibited more increase of the thickness in the case of preservation in charging condition under high temperature environment compared with the non-aqueous electrolyte secondary battery of Comparative Example 8 employing the non-aqueous electrolyte not containing cyclic ether, and the effects obtained in each of the non-aqueous electrolyte secondary batteries described above cannot be attained.

Although the present invention has been fully described by way of examples, it is to be noted that various changes and modification will be apparent to those skilled in the art.

Therefore, unless otherwise such changes and modifications depart from the scope of the present invention, they should be constructed as being included therein.

1. A non-aqueous electrolyte secondary battery comprising a positive electrode using a positive electrode active material consisting of metal composite oxide containing lithium having a laminated structure, a negative electrode, and a non-aqueous electrolyte dissolving an electrolyte in a non-aqueous solvent, wherein
said metal composite oxide containing lithium which is used as said positive electrode active material contains 50 mol % or more of nickel in metal excluding lithium, and cyclic ether is added in a range of 0.1 to 2 volume % to said non-aqueous electrolyte.

2. The non-aqueous electrolyte secondary battery according to claim 1, wherein the positive electrode active material is metal composite oxide containing lithium presented by the general formula LiₐNi_{b}Co_{c}M_{d}O₂₊ₑ, where M is at least one element selected from Al, Mn, Mg and Ca, 0.2≦a≦1.2, 0.6≦b≦0.9, 0.1≦c≦0.4, 0≦d≦0.2, −0.2≦e≦0.2, and b+c+d=1.

3. The non-aqueous electrolyte secondary battery according to claim 1, wherein said cyclic ether has unsaturation bond.

4. The non-aqueous electrolyte secondary battery according to claim 3, wherein said cyclic ether is furan or furan compound.

5. The non-aqueous electrolyte secondary battery according to claim 4, wherein said cyclic ether is furan or 2-methyl furan.

6. The non-aqueous electrolyte secondary battery according to claim 1, wherein said non-aqueous solvent is a mixed solvent containing cyclic carbonate and chain carbonate.

7. The non-aqueous electrolyte secondary battery according to claim 6, wherein said mixed solvent containing cyclic carbonate and chain carbonate contains cyclic carbonate in the range of 10 volume % to 30 volume %.

8. The non-aqueous electrolyte secondary battery according to claim 1, wherein vinylene carbonate is added to the non-aqueous electrolyte in the range of 0.5 weight % to 4.0 weight %.

9. The non-aqueous electrolyte secondary battery according to claim 1, wherein said negative electrode uses graphite material as a negative electrode active material.

10. The non-aqueous electrolyte secondary battery according to claim 1, wherein said negative electrode uses a negative electrode mixture containing the negative electrode active material and a binding agent and a density of the negative electrode mixture is within the range of 1.5 g/cm³ to 1.9 g/cm³.
